(19) United States
(12) Patent Application Publication
(10) Pub. No.: US 2021/0069752 A1
(43) Pub. Date: Mar. 11, 2021

(54) Sorting Disc for a Disc Screen Sorter

(71) Applicant: LANXESS Solutions US Inc., Shelton, CT (US)

(72) Inventors: Matthew Burdzy, South Windsor, CT (US); Thomas H. Peter, Southbury, CT (US); Matthew Sennett, Naugatuck, CT (US); Ian Laskowitz, Bantam, CT (US)

(73) Assignee: LANXESS Solutions US Inc., Shelton, CT (US)

(21) Appl. No.: 17/040,583

(22) PCT Filed: Mar. 25, 2019
(86) PCT No.: PCT/US2019/023803

§ 371 Date: Sep. 23, 2020

Related U.S. Application Data
(60) Provisional application No. 62/646,977, filed on Mar. 23, 2018.
(60) Provisional application No. 62/658,061, filed on Apr. 16, 2018.

(51) Int. Cl. B07B 1/15

(52) U.S. Cl. CPC B07B 1/155

(57) ABSTRACT

The durability of sorting discs used on disc screens, e.g., star discs comprising a body and a plurality of fingers extending radially from the body, may be improved by increasing the deflection of the fingers. Provided are methods for improving the durability of sorting discs, and sorting discs with improved durability.

This application claims benefit under 35 USC 119(e) of U.S. Provisional Application No. 62/646,977 filed Mar. 23, 2018, and U.S. Provisional Application No. 62/658,061 filed Apr. 16, 2018, the disclosures of which are incorporated herein by reference.

Provided is a method for improving the durability and service lifetime of an elastomeric sorting disc, e.g., star disc, and an improved, highly durable sorting disc, for example, a more durable star disc for use in a disc screen for sorting materials, such as a disc screen used in sorting recyclable materials.

### BACKGROUND

Disc screens are used to separate materials, such as wood chips, into different fractions according to size. More recently disc screens have been used to separate or classify mixed recyclable materials based on size.

Material recycling facilities (MRFs) use rotating disc machines to separate recycled consumer, commercial and industrial waste into reusable streams of paper, plastics, cardboard, metal, and glass. The mixture of waste that arrives at a recycling facility is loaded onto a system of conveyors, and is transported through a series of machines that use various separation technologies to isolate like materials for reuse. The equipment used to separate the recycling stream includes drumfeeders, old corrugated container (OCC) separator screens, old newspaper (ONP) screen machines, optical sorting systems, glass breaker screens, magnets, elliptical ballistic separators, eddy current separators, and the like. Recycling facilities such as these are known to process 30 to 50 metric tons of recyclable material an hour.

A variety of rotary disc separating screens, using a variety of rotary discs, are known. U.S. Pat. No. 4,795,036 discloses a machine having a series of rotating shafts with discs aligned in an alternating arrangement on adjacent shafts, creating a predetermined size or opening to physically separate a process stream that contains different size materials. The sorting machine uses detachable two-piece discs that can easily be mounted on the corresponding shaft without removing the shaft or having to weld the discs onto the shaft.

U.S. Pat. No. 5,450,966 discloses a separating machine that used single-piece flat discs with 3, 4 or 5 sides, i.e., rounded triangle, rounded square, or rounded pentagon, to reduce jamming between shafts, increase the movement of the process material to create more sifting effects, and to easily replace damaged discs.

U.S. Pat. No. 6,149,018 discloses the use of primary and secondary discs, which can be made from rubber, to improve performance, reduce maintenance, and reduce jamming between the disc and adjacent shaft while effectively separating old newspaper from old corrugated cardboard.

U.S. Pat. No. 6,296,124 discloses a sorting apparatus that uses a single-piece disc with an interacting tooth design to reduce jamming and clogging of screens by wood, nails, rocks, and the like.

U.S. Pat. No. 6,318,560 discloses a removable two-piece square disc with rounded edges that can be removed from the shaft without disassembling the apparatus when the disc is damaged or worn. It was disclosed that discs wear quickly and undergo significant damage when exposed to a heavy volume of recyclable material. A two-piece disc with a rigid inner frame and a softer outer material that can be clamped directly onto a shaft without disassembling the shaft from the apparatus is used to reduce the amount of maintenance needed compared to a single-piece disc. The disc is made from a hard, durable material with a high coefficient of friction, such as rubber. For the disc to function well, it must have a flexible impacting surface with high abrasion resistance and a high coefficient of friction. A coating may also be applied to the impacting surface. A rubber having a 50-55 durometer hardness that is compression molded around a rigid metal frame that imparts stiffness is preferred.

Other discs that can be mounted onto a shaft without disassembling the apparatus are known. For example, U.S. Pat. Nos. 7,004,332, 7,578,396, and 7,661,537 disclose a multi-finger, single-piece, split clamshell disc with a notch and slot on opposing sides that can be opened and slipped over the shaft, and then fastened in place.

A disc screen typically comprises a frame in which a plurality of rotatable shafts are mounted in parallel relationship. A plurality of discs are mounted on each shaft, and a drive, e.g., a chain drive, rotates the shafts in the same direction. The discs on one shaft interleave with the discs on each adjacent shaft to form screen openings between the peripheral edges of the discs. The size of the openings determines the dimension of the articles that will fall through the screen.

Rotation of the discs, which have an irregular outer contour, agitates the mixed recyclable materials to enhance classification, and propels or transports the larger articles that are too big to fall between the discs to an output, where the larger articles pour off the disc screen. The smaller articles fall between the discs onto another disc screen or conveyor, or into a collection bin.

As discussed above, various constructions of disc screen sorters and the discs used thereon are known. Star discs, i.e., discs having multiple projections, or fingers extending from a central body, are known, e.g., U.S. Pat. Nos. 9,027,762, 9,056,334 and US Pub. Pat. Appls. 20100264069 and 20110303587. The fingers are generally made from rubber or another elastomer, and the body will typically also comprise rubber or elastomer. Most commercial star discs are made from rubber.

In use, a sorting disc, such as a star disc, will experience wear and degradation due to aging, mechanical stress, abrasion, etc., and eventually will need to be replaced. Wear does not necessarily occur at the same rate for all discs on a disc screen, nor are the sources of wear identical for all discs. For example, articles to be sorted are poured or dumped onto the disc screen as a stream, which stream typically impinges on only a portion of the screen directly. The discs in this area where the article stream makes initial contact are subjected to greater impact forces than other discs, and are therefore exposed to more physical damage and wear. Also, when a disc screen used for recyclables is operated at normally high volumes, such as the 30 to 50 metric tons an hour mentioned above, excessive debris can build up between the discs. The additional contact between this debris and the discs can create a severe strain on the discs, which can lead to early failure of the discs.

After a certain amount of use or abuse, a sorting disc, whether made of rubber or some other elastomer, will need to be replaced. Damage that can lead to the replacement of an elastomeric star disc includes the fracture or sudden loss of a finger, or parts of a finger, or the gradual loss of mass from the disc, often from the fingers, due to abrasion, etc. Once a certain amount of loss occurs, due to either breakage or gradual wear, the disc will no longer be functional. Reducing the rate of wear, which slows loss of mass from the disc over time, can therefore provide a disc that can be used for a longer period of time before it needs to be replaced.

The task of providing such a disc, however, is made more difficult by the fact that many of the causes of wear and degradation of sorting discs are not fully known or understood. For example, as shown herein, simply using more durable materials in manufacturing the disc will not necessarily provide discs that last longer in use. That is, attempts made to lengthen the usable lifetime of commercial star discs, i.e., increase the time before a disc needs to be replaced, by replacing the rubber from which they were made with an elastomeric material that is physically stronger and typically more durable, e.g., a polyurethane having greater tensile strength, greater tear strength, more resilience, and/or more abrasion resistance produced, erratic and overall disappointing results. In some cases, a star disc prepared from a “weaker” elastomer, e.g., an elastomer having a low tear strength, outlasted a star disc prepared from a “stronger” elastomer having a much higher tear strength. Surprisingly it was found that seemingly small changes in the shape of a star disc can lead to significant improvements in durability and open the door for the effective use of a wider variety of elastomers.

While the exact point at which a disc is considered to no longer be useful might vary somewhat from user to user, in most instances this determination is related to the loss of mass due to either gradual wear, such as erosion due to abrasion, or catastrophic wear, such as when a portion of the disc, e.g. part of a finger, breaks off.

The present invention provides elastomeric sorting discs that are more resistant to wear, both gradual and catastrophic wear, than is currently available. The inventive discs lose mass more slowly in use, i.e., they are more durable, and can therefore be used for longer periods of time before they need to be replaced. A convenient yardstick by which the discs of the present invention can be shown to be more durable than those presently available is the time it takes for the disc to suffer, e.g., a 10% weight loss under standard operation of a disc sorter. By extending the amount of time that an elastomeric star disc can be used on a disc sorter, the more durable discs of the invention allow one to operate the sorter for a longer period of time before having to replace the disc, saving time, effort, inconvenience, and money.

For a better understanding of the present invention, together with other and further features and advantages thereof, reference is made to the following description, taken in conjunction with the accompanying drawings. The scope of the invention will be pointed out in the appended claims.

### SUMMARY OF THE INVENTION

The invention provides methods for improving the durability and performance of elastomeric sorting discs, for example, star discs containing a plurality of fingers extending from a central body. It was surprisingly found that altering the design of the discs by making the fingers longer and/or thinner, results in a disc that wears, i.e., loses mass, more slowly as seen in the longer time it takes to show a certain loss, e.g., a 10% weight loss. Methods for improving disc durability by proper elastomer selection, e.g., polyurethane selection, are also developed.

Certain embodiments of the invention provide a star disc, readily prepared from elastomeric materials by cast molding, injection molding or similar processes, having improved durability relative to currently used discs, e.g., slower weight loss over time. A typical inventive disc may have a generally round or ovoid body with a plurality of fingers, e.g., from 2 to 18, or from 4 to 12, extending from the body. In addition, the body may have a central opening for mounting of the disc on a shaft. In one embodiment, the inventive disc may have fingers that are proportionally longer and/or thinner relative to the body of the disc, and the fingers may exhibit a greater degree of deflection than fingers on currently used star discs of comparable size. In some particular embodiments of the invention, the star disc may have six fingers. In other particular embodiments, the star disc may have 8, 10 or 12 fingers, and, in still further embodiments, the star disc may have an odd number of fingers, e.g., 5, 7, 9 or 11.

In many embodiments of the invention, the discs may be prepared from polyurethanes, e.g., in some embodiments, improvements were obtained when using elastomers prepared by curing a polyurethane prepolymer with an amine curative, for example a diamine. In other embodiments, the discs may be prepared from rubber, including rubbers comprising butadiene and/or isoprene monomers, or other elastomers. Generally, the fingers and body may be formed from the same elastomer, and the body may include one or more splits defining a pair of opposing ends for opening the disc during installation. In some embodiments, the body may comprise materials in addition to an elastomer. The additional materials may fastening devices, such as bolts, to close the disc at the site of the splits when in use, and/or reinforcing materials, such as reinforcing fibers or webs of glass, polymers, or metals such as metal mesh. The reinforcing materials may be present in either the body, fingers, or both, while in other embodiments, such reinforcing materials may be absent.

When present, the reinforcing material can be found throughout the entire disc, or it may only be in certain regions. For example, in various embodiments, wire mesh, expanded metal, perforated metal, or welded metal structures, are incorporated at and near the end of the fingers to reduce wear, maintain the geometry and increase the operating lifetime of the disc without impacting the properties, such as flexibility, of the rest of the disc. It should be appreciated that the metal structures can take various forms and can include openings to allow the polymer to better encapsulate such metal reinforcement such as in the case of wire mesh.

One broad embodiment relates to a process for improving the durability of a star disc through analysis of possible failure modes. This may include examining the results of systematic alterations to the physical design and/or material construction of the disc, making adjustments to the disc, and then optionally re-examining. Increased durability is evidenced by less weight loss over time, that is, it will take longer to reach a selected amount of weight loss, and thus a longer usable lifetime. Thus, improvements in durability can be conveniently measured by weighing the discs after intervals of use, e.g., on a working disc sorter, and comparing the experimental discs vs standards.

By analyzing failure modes and altering disc characteristics, the design of the disc was changed to make the fingers, or at least a portion of the fingers, thinner and/or longer in order to increase the deflection of the fingers, or portion of the fingers, at a given force as a means of improving durability. Other means for increasing deflection and improving durability, e.g., by proper selection of elastomer, are also available. The fingers can be made longer without altering the effective outer diameter of the disc by reducing the diameter of the body. It is possible that the optimal shape of the star disc could depend to some extent on the elastomer used in its production, and the selection of the most suitable elastomer may depend to some extent on the shape of the fingers and/or disc. For example, evaluation of various elastomers after adjustment of the shape of the disc can lead to further improvements as shown herein.

There is broadly contemplated, in accordance with at least one embodiment of the present invention, an elastomeric sorting disc (e.g., FIG. 3, Nr. 1) for use with a sorting apparatus, said disc (e.g., FIG. 3, Nr. 1) comprising a disc body (e.g., FIG. 3, Nr. 2) configured in a generally circular or generally ovoid shape defining a radial perimeter (e.g., FIG. 3, Nr. 3) at an outer edge of the body from which a body diameter (e.g., FIG. 2, Nr. BD) is measured, a plurality of fingers (e.g., FIG. 3, Nr. 4) integrally formed as appendages joined to the body (e.g., FIG. 3, Nr. 2) at said perimeter (e.g., FIG. 3, Nr. 3), each finger (e.g., FIG. 3, Nr. 4) extending outwardly from the radial perimeter (e.g., FIG. 3, Nr. 3) to an outer edge (e.g., FIG. 3, Nr. 6), wherein the outer edges of the fingers of the disc define a circle from which an outer diameter (e.g., FIG. 2, OD; FIG. 3, Nr. 5) is measurable; wherein said body has a centrally positioned axial opening (e.g., FIG. 3, Nr. 7) therethrough of a size and shape capable to fit onto a shaft of said apparatus, wherein said body optionally has a slit (e.g., FIG. 3, Nr. 8, FIG. 1, SL) formed through the wall of the body (e.g., FIG. 3, Nr. 2) from the perimeter of the body to the axial opening, and wherein the fingers are capable of a deflection of greater than 5 degrees at a force of 50 lbf (222 Newtons), preferably greater than 10 degrees at a force of 50 lbf (222 Newtons), particularly preferred greater than 16 degrees at a force of 50 lbf (222 Newtons). In another embodiment, the elastomeric sorting disc has 4-16 fingers, preferably 6-8, particularly preferred 6. In another embodiment, the elastomeric sorting disc comprises polyurethane. In another embodiment, the elastomeric sorting disc comprises an effective length (e.g., FIG. 2, EL) measured along a straight line through the finger extending from the radial perimeter to the outer edge of the finger, at least one thickness measured in a plane parallel to the plane of the circle defined by the outer radial edges of the fingers, and at least one width measured in a plane perpendicular to the plane of the circle defined by the outer edges of the fingers; wherein thmax (e.g., FIG. 2, thmax) is the thickness measured at the thickest part of the finger between the midpoint of the finger and the outer edge; thmin, in a further embodiment, is the thickness measured at the least thick part of the finger between the radial perimeter and the part of the finger where thmax is measured; wmid represents the width measured at the midpoint along the line of EL. In one embodiment, thmax/EL is less than or equal to 0.38, preferably about 0.15 to about 0.34, thmin/EL is less than or equal to 0.35, preferably about 0.12 to about 0.25, BD/EL is greater than or equal to 0.5, and wmid/EL is less than or equal to 0.75. In another embodiment, the elastomeric sorting disc has an EL about 60 to about 375 mm, one or more thicknesses of about 15 to about 130 mm, and at least one width of about 40 to about 260 mm. In a further embodiment, the elastomeric sorting disc has an OD (e.g., FIG. 3, Nr. 5) about 325 to about 335 mm, a BD (e.g., FIG. 3, Nr. 3) about 100 to about 140 mm. In another embodiment, the elastomeric sorting disc has an OD about 330 mm and a BD about 115 to about 125 mm. In another embodiment, the elastomeric sorting disc has a thmax/EL about 0.18 to about 0.30; a thmin/EL about 0.18 to about 0.23; and a BD/EL about 0.6 to 1.0. In another embodiment, the elastomeric sorting disc is formed of a polyurethane elastomer. In another embodiment, the body and fingers are formed as a single piece, in a single molding process, from the same polyurethane elastomer. In another embodiment, the polyurethane elastomer is prepared by crosslinking an isocyanate capped prepolymer with an amine curative. In another embodiment, the elastomeric sorting disc comprises metallic and/or non-metallic fillers, fibers, fabrics, and/or mesh reinforcement material which may in one embodiment be positioned at or near the end of the fingers. In another embodiment, the reinforcement material is a metal mesh.

In another embodiment, there is a method for improving the durability of an elastomeric sorting disc for a disc sorting apparatus, the disc comprising a disc body and a plurality of fingers extending radially from the body, and the method comprising, in comparison with fingers of conventional discs, increasing deflection of the fingers, or at least portions of the fingers, by at least one of making the fingers, thinner, longer, or both thinner and longer than the fingers of conventional discs, and forming at least the fingers with an elastomer comprising properties leading to increased deflection. In another embodiment of the method, the deflection of the fingers, or portions of the fingers, is increased by selecting an elastomer with a 10% modulus of less than 1000, preferably with a 100% modulus of less than 1000. In another embodiment of the method, the deflection of the fingers, or portions of the fingers, is increased by making the fingers thinner, longer, or both thinner and longer. In another embodiment of the method, metallic and/or non-metallic fillers, fibers, fabrics, and/or mesh reinforcement material, either throughout the entire disc or only in certain regions are incorporated into the elastomeric sorting disc. In another embodiment of the method, the metallic and/or non-metallic fillers, fibers, fabrics, and/or mesh reinforcement material are incorporated at or near the end of the fingers.

For a better understanding of the present invention, together with other and further features and advantages thereof, reference is made to the following description, taken in conjunction with the accompanying drawings, and the scope of the invention will be pointed out in the appended claims. As used in this description and the appended claims, the singular forms “a,” “an,” and “the” include plural referents unless the content clearly dictates otherwise.

### BRIEF DESCRIPTION OF THE DRAWINGS

FIG. 1 shows the shape and dimensions of a commercial ONP star disc.

FIG. 2 shows the shape and dimensions of a redesigned ONP sorting disc according to an embodiment of the invention.

FIG. 3 shows a sorting disc according to an embodiment of the invention.

FIG. 4 shows a second redesigned ONP sorting disc according to an embodiment of the invention.

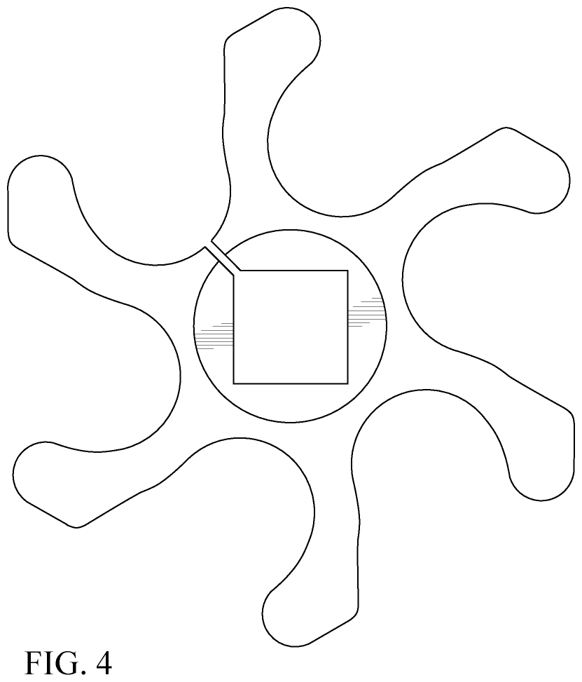

FIG. 5 is a perspective view of a second redesigned ONP sorting disc of FIG. 4.

FIG. 6 illustrates one method for determining the angle of deflection in degrees of fingers of a sorting disc.

FIG. 7 illustrates a mold for casting a sorting disc inclusive of a reinforcing material.

### DESCRIPTION OF THE INVENTION

Initial efforts to improve the durability of a rubber star disc by substituting stronger or more wear resistant elastomers for the rubber used in its manufacture were coupled with an investigation into the mechanisms causing star discs to wear and eventually fail. For example, there are a number of physical properties that contribute to the overall performance characteristics of an elastomeric material. Standard tests for measuring hardness, tensile strength, tear strength, modulus, compression, rebound etc., are known, and are typically used to characterize different elastomeric materials. A variety of factors cause wear, such as, loss of disc mass due to abrasion, loss of resiliency in a projecting arm of a star disc, cracking, or deformation of the disc on exposure to the environment, the stresses of operation, etc. However, it is not known which factors are the most significant causes of early failure in star discs, i.e., those factors responsible for highest rate of erosion or implicated in breakage or loss of a finger, and what polymer properties need to be adjusted to combat them. It was hoped that by careful selection of polymer properties in a series of test discs, the factors most responsible for early failure of current star discs might be revealed.

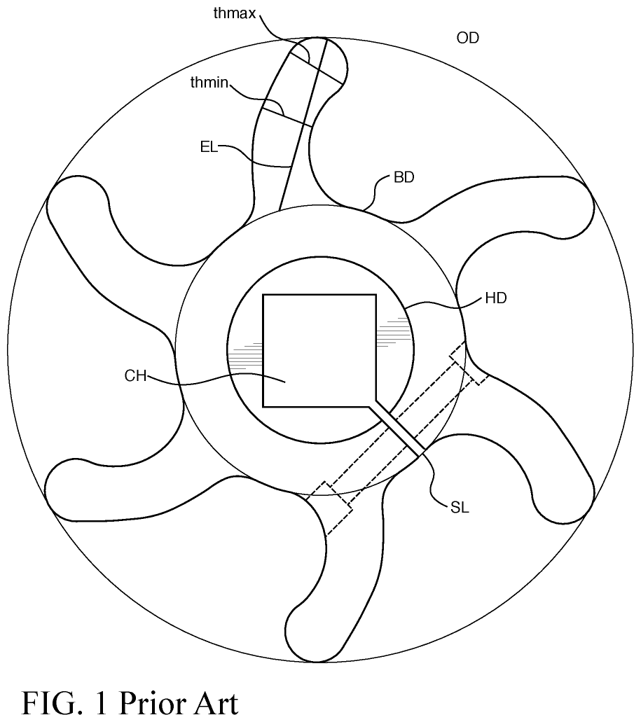

To this end, “old newspaper” star discs (ONP discs) were prepared from an assortment of polyurethanes matching the shape and dimensions of a commercial rubber star disc used in a disc screen for sorting materials in a municipal recycling stream. As shown in FIG. 1, common commercial discs may include six fingers (F), and the outer edges of the fingers of the disc define a shape, in this case a circle, from which a finger diameter, or outer diameter, OD, is measured. The fingers extend radially outward from the body (B), in this case a circular body, wherein the outer edge defines a perimeter from which an inner or body diameter (BD) is measured. The fingers have an effective length (EL) measured along a straight line through the finger, extending from the body perimeter to the outer edges at the distal end of the fingers. In this case the fingers are arced, but in some other embodiments the fingers are not. The center hole (CH) for mounting the disc on a shaft is a square in this case, in other embodiments the shape and size of the central opening will vary depending on the size and shape of the shaft. A raised hub (H) near the center of the body may be present. Such hubs are generally included for spacing of the discs on a shaft.

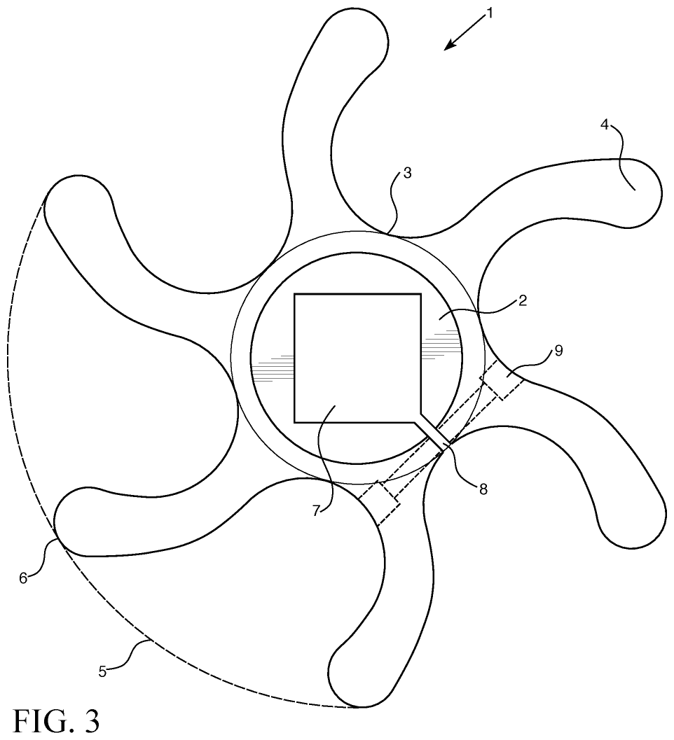

A slit or a slice (SL) may be formed through the wall of the body from the outer surface or perimeter of the body, through to the inner surface of the body, so that the disc can be opened, typically by hand, for mounting the disc on a shaft or removing the disc from a shaft without the need for removing the shaft from the sorting machine. Since the slit essentially separates the body portions on opposite sides of the slit, the disc may also include a feature for closing the slit and fastening the body portions together, thereby making it possible to keep the disc closed and held in position on its corresponding shaft during use. In the embodiment shown, such a feature is configured as an aperture, represented with dotted lines (e.g., FIG. 3, Nr. 9), passing through each of the body portions across the slit, and configured for receipt of a fastener, e.g., a bolt, etc., therein.

The fingers have a thickness (th) and a width (w) measured in a plane perpendicular to that in which the thickness is measured (in the illustrated embodiment, the width is perpendicular to the plane of the drawing). The shape and thickness of the finger may vary as one progresses from the body perimeter to the distal end of the finger, and the distal end of the finger, or finger-tip, can have any shape. Thus, in many embodiments, the fingers may be said to have more than one thickness and/or more than one width. Often, the fingers are designated as having a maximum thickness (thmax), representing the thickest point of the finger, and which may extend from the midpoint to the tip of the distal end, and a minimum thickness (thmin), representing the thinnest point of the finger, and which may extend between the thickest point near the distal end and the body perimeter. In some embodiments the thickness and/or width of the fingers is constant for most or all of the length of the finger.

The body of the disc also has a width (w) measured in a plane perpendicular to that in which the thickness (th) of the fingers is measured, and, obviously, also perpendicular to the plane in which the outer diameter is measured. In many commercial discs, and in many discs of the invention, the width of the fingers will be the same as, or similar to, the width of the body per se, i.e., the body excluding the hub. As shown, the presence of a hub adds to the width of the body in the area of the hub.

The commercial disc used as a standard was made of rubber and had the shape illustrated in FIG. 1, with an outer diameter (OD) of 330 mm; a body diameter (BD) of 155 mm; a body width of 60 mm; a square 60 mm×60 mm center hole (CH); a hub having a diameter of 100 mm; and a width of 100-105 mm. The fingers have an effective length (EL) of 90 mm, a minimum thickness (thmin) of 28.5 mm, a maximum thickness (thmax), measured at the thickest point of the distal end, of 32.25 mm, and a width (w), measured at a point half way along a line defining the effective length of the finger, of 60 mm.

Polyurethane discs of FIG. 1, with the above dimensions, were prepared and mounted in a commercial disc screen along with conventional rubber discs. The disc screen was then used to separate a recycling stream according to standard protocols. The physical properties of the polyurethanes were known before the test was run, and the assumption was that by correlating the failure times with the properties of the polyurethane of the discs, the properties needed for greater durability could be determined, from which the factors most responsible for failure could be deduced.

The study included polyurethanes having improvements in one or more physical properties relative to the rubber used commercially, e.g., greater tensile strength (ASTM D412), rebound (ASTM D2632), abrasion resistance (DIN abrasion, ATSM D5963, Method A 10 Newtons), tear strength (split tear ASTM D470), modulus (ASTM D575), etc., and it was felt that a possible replacement for the rubber elastomer would also be identified. In choosing an elastomer, it was also generally understood that the discs are typically mounted by opening the disc at the slit and sliding the disc over the shaft from the side. Thus, the elastomer had to be sufficiently flexible so that the disc could be opened wide enough to accommodate the cross section of the shaft, in this case, at least 60 mm. This puts a practical limitation on the elastomer used in preparing the disc, as the elastomer should be chosen so that the disc can be opened at the slit with a reasonable amount of force, e.g., a force of less than 100 lbf, less than 75 lbf, or 50 lbf or less.

While some of the polyurethane discs did outlast the rubber discs, the differences were not as large as expected. Further, the results were scattered and seemed to offer no clear direction as to which property in the elastomer to enhance to provide greater durability.

One polyurethane sample, however, surprisingly resulted in unexpectedly improved durability. This polymer had significantly lower tear strength, 36 lbf/in, compared with the rubber used in the commercial disc, 58 lbf/in, yet provided a disc that took twice as long to exhibit a 10% weight loss as compared with the commercial rubber disc.

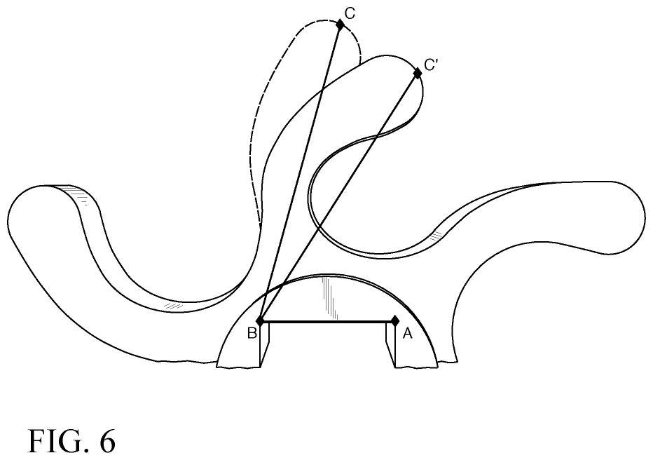

The star disc from the polyurethane with tear strength of 36 lbf/in was therefore subjected to exhaustive testing of its physical properties, revealing that the fingers had greater deflection at a given applied force than those of the conventional rubber disc. It was found that the force needed to generate a 1-inch deflection (see FIG. 6) in the finger of the polyurethane star was 35 lbf, whereas the force to generate a 1-inch deflection in the finger of the conventional rubber star was 52 lbf. Deflection can be measured as the amount of deflection (bending) caused by a given force. While the amount of deflection can be described as a distance, e.g., inches, centimeters etc.; when comparing deflection of articles of different sizes, it often may be more relevant to measure the amount of deflection by the angle of displacement of the finger or the arc traced by the displacement. A calibrated compression machine, as known to those skilled in the art, can be used for force application such as a Renew RT 4206 instrument.

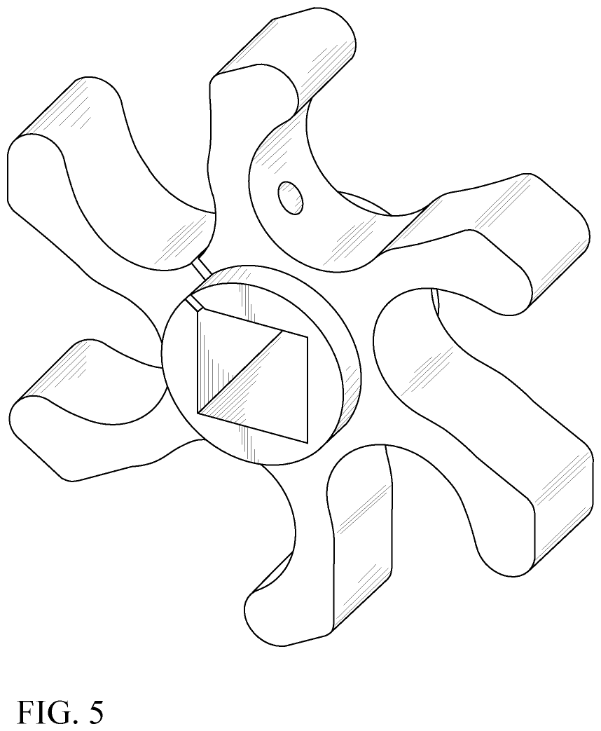

FIG. 5 shows a portion of an embodiment of a six-fingered disc, and illustrates a 1-inch deflection of a finger. The disc has a square central opening for mounting on a square shaft, and, in this embodiment points A and B, points along a line defined by the edge of the opening are used to define a reference line. The figure shows a star disc with a deflected finger (dashed line) in relation to the same finger (solid line) prior to deflection. Points C and C′ are points at the distal end of the same finger, C is on the non-deflected finger, C′ is the same point on the finger when displaced by the deflection. The angle of deflection in this case was conveniently measured by determining the difference between the angle defined by the lines AB and BC for the non-deflected star, and that defined by the lines AB and BC′ for the deflected star. On the star disc above, the points “A” and “B” are 60 millimeters apart and the outer diameter of the disc is about 330 mm. The angle is 74 degrees before the finger is deflected and 58 degrees after the finger is deflected, a difference of 16 degrees. In the case of such a star disc, a one-inch displacement therefore correlates to a 16° deflection. As the deflection increases, the distance between C and C′ increases as does the deflection angle.

While certain properties, such as bounce back, resilience, flexibility, hardness, modulus, etc., are inherent in the elastomer per se, deflection is measured for the article and largely reflects the design of an object.

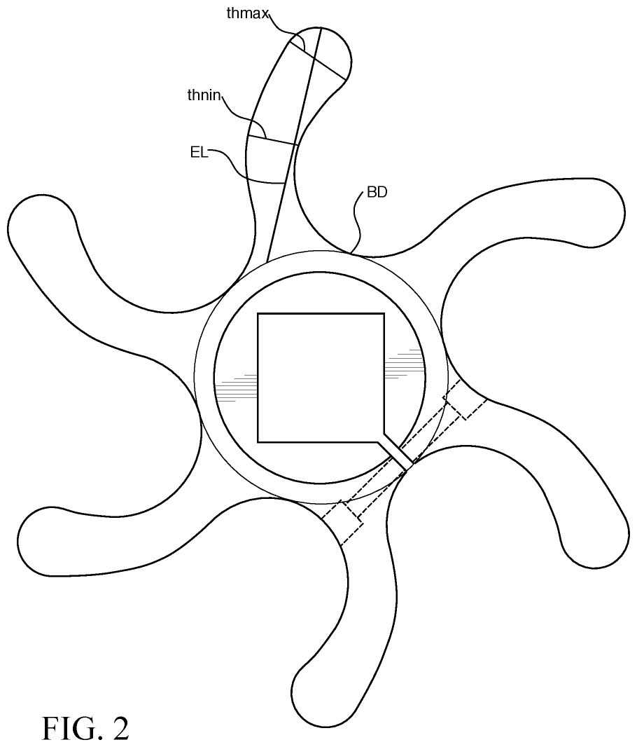

Following the process of the invention, star discs were prepared from an assortment of polyurethanes using a design similar to that above, but wherein the fingers, in an attempt to provide greater deflection, were configured to be longer and thinner. The outer diameter, central hole, and body of the modified disc had the same dimensions as above, but to accommodate the greater length of the fingers the body was designed to have a smaller inner diameter, see FIG. 2., where thmax is 32.10 mm, thmin is 32.50 mm, EL is 107.6 mm, and BD is 119 mm. For reference, any dimensions not listed on FIG. 2 should be considered to be the same as those in the disc of FIG. 1. Discs made using the new design of the invention had increased deflection and greater durability than discs made of the same material but using the design of FIG. 1. Durability (measured by time to 10% wt loss) of the inventive discs using certain polyurethane elastomers and the modified design of FIG. 2 was surprisingly found to be more than double that of conventional commercial rubber discs.

Thus, at least two methods for preparing discs with greater durability were suggested from the results:
increasing finger deflection by using an elastomer with increased flexibility or lower modulus, e.g., 10%, 20%, 50% or 100% modulus, and
increasing finger deflection by increasing the length and/or decreasing the thickness or the fingers.

In some embodiments, the selected polyurethane has a 10% modulus at less than 1000 psi, e.g., 800 psi or less, 600 psi or less, 500 psi or less, 400 psi or less, 300 psi or less, 200 psi or less, or 10 psi or less. With these improvements in hand, additional improvements could be explored in attempts to address other modes of wear and degradation, for example, an elastomer with high tear strength or abrasion resistance that provides overly stiff fingers in the original, commercial design, can be used to prepare a star with the modified longer and/or thinner fingers.

For example, in one test series, a star disc prepared according to the commercial star disc design above from a polyurethane with a high tear strength, 111 lbf/in, placed on a screen sorter exhibited about the same rate of material loss as a similar disc prepared from a polyurethane with a tear strength of only 36 lbf/in, even though the weaker polyurethane star was positioned at the point that received more direct impact from the recyclable material stream than the stronger polyurethane star. Given the large difference in strength between the two polymers, it was surprising that the disc from the stronger polymer could barely match the performance of the disc comprising the less strong material. However, in the original commercial design, this polymer produced fingers with a one inch deflection force of 113 lbf. This polymer was then used in a disc of the new, modified design of FIG. 2, producing a disc requiring a force of only 30-35 lbf to produce a finger deflection of 1-inch, i.e., 16°, and greater durability.

The above discussion illustrates a method for improving the durability of a star disc by modifying the shape and/or materials of preparation in response to specific data generated regarding loss modes. In the above case, this led to a surprising new design for a star disc that provided greater durability by increasing finger deflection. One broad embodiment of the invention therefore provides a process for improving the durability of an elastomeric sorting disc, in particular a star disc comprising a plurality of fingers attached to a body, e.g., 3-16, 4-12 or 6-8 fingers, the process comprising:
i) measuring the rate of material loss from the disc during use,
ii) analyzing possible failure modes of the disc by
   a) making design and/or material construction alterations to the disc, which alterations produce a change in at least one measurable physical characteristic or performance property, to prepare an altered disc,
   b) ascertaining the material loss of the altered disc by exposing the altered disc to standard, accelerated, or overly demanding use,
   c) measuring performance properties of the altered discs before and/or after exposing the altered disc to standard use or accelerated or overly demanding use,
   d) correlating the rate of material loss of the altered disc with the changes in the at least one measurable physical characteristic produced by the alteration in a),
iii) making adjustments to the physical design and/or material construction of the disc based on the correlation from iid) to produce a modified star disc, and
iv) optionally measuring the rate of material loss of the modified disc.

A measurable physical characteristic is a property inherent to the material used in preparing the disc, e.g., elastomer hardness, resistance to loss from friction, rebound, split or trouser tear strength, tensile strength, etc.

A measurable performance property is a property associated with the manufactured disc, and reflects both the physical properties of the material used in preparing the disc and the design of the disc, e.g., finger deflection, weakness at the joint of finger and body, force needed to spread a split disc for mounting on a shaft, etc. The effect of tapered vs straight fingers, or non-uniform cross section are design features that could impact these physical properties.

For example, in the present process, the design and/or material construction alteration may produce a change in at least one measurable physical characteristic such as hardness, resistance to loss from friction, rebound, split tear strength, trouser tear strength and tensile strength; or in at least one measurable performance property such as finger deflection, weakness at the joint of finger and body, force needed to spread a split disc for mounting on a shaft, etc.

Further improvements may be obtained by analyzing possible failure modes of the modified disc by making design and/or material construction alterations to the modified disc and repeating the process above.

Broadly, the operating lifetime of a sorting disc is the number of hours the disc is in service on a rotating disc machine before being removed due to wear and loss of efficiency. Wear includes changes in geometry, loss of material, and/or damage to the part, which affects the efficiency, separation, and throughput of the process stream. A variety of disc designs are used in rotating disc machines, e.g., one, two and multiple-piece designs that typically can be mounted and removed from a shaft without disassembling the machine. There are also multi-cornered discs, discs with fingers, discs with teeth, and discs with other features that enable the process stream to be separated and transported during operating. These various discs may be used in a number of applications under a variety of conditions. While the point at which a particular disc is determined to no longer be functional may vary depending on where and how the disc is used, a more durable disc, will lengthen the amount of time before the failure point is reached. As a result, it is envisioned that a longer life with less frequent replacement will result in monetary savings in the number of discs needed for operation of a sorter, and will reduce down time typically needed to replace the worn discs.

As the disc rotates, damage and wear reduce the efficiency and throughput. Material wears off the edges, sides, and faces of the disc, changing the appearance, dimensions, and mass of the disc. Some of the wear is caused by the disc impacting debris on an adjacent shaft, which builds-up during operation, reducing or eliminating any clearance between the disc and shaft. Discs are also damaged by material in the process stream impacting and/or jamming between rotating shafts, which can lead to cuts, cracks, gouges, grooves, missing fingers, missing teeth, and completely destroyed discs. The wear and damage typically become visible during shut downs where visual observations are typically used to determine when to remove worn and/or damaged discs. While one can measure and quantify changes to the disc relative to operational time, cause and effect correlations are often difficult, and once one cause of failure is remedied, other, often surprising, causes of failure become apparent. For example, during the present work, it was discovered that the build-up of debris between the rotating disc and adjacent shaft reduces or eliminates clearance and has an important impact on durability. The methods described herein illustrate how issues related to disc wear and damage can be evaluated and resolved.

Additional embodiments of the invention provide a durable elastomeric sorting disc for use with a sorting apparatus. While the disc body may have generally any shape, an embodiment may comprise a disc body configured in a generally circular or generally ovoid shape and defining a radial perimeter. A plurality of elastomeric fingers may be integrally formed with the body as appendages at the perimeter of the body, with the fingers extending outwardly in a radial manner from the perimeter, often in a evenly spaced manner disposed about the perimeter. In an embodiment, the body may also have a centrally positioned opening therethrough, of a size and shape configured to fit onto a shaft of the sorting apparatus In an embodiment, the fingers exhibit a 16° deflection at a force of 50 lbf or less.

The terms “generally circular” and “generally ovoid” reflect, in part, the reality that slight irregularities in shape, either by design, or those which may occur in molding, shipping, mounting, or use, are common. They also reflect the reality that when fingers are integrally attached at the radial perimeter, the overall shape of the body in isolation may not correspond exactly to a rigorously defined, regular geometrical shape. The generally circular or ovoid perimeter defined by the body, in a disc comprising fingers, can be readily assigned by the largest generally circular or ovoid shape circumscribed within the body by points on the perimeter having a roughly consistent radius from the center of the body, see FIG. 3. The complete shape and size of the body portion may be readily inferred therefrom.

Further, regarding the body and other parts of the disc, it is understood that throughout this application, and consistent with the art, the actual shapes of the disc components, e.g., the body, opening therein, fingers etc., may be slightly irregular, e.g., corners of squares may be rounded, a pentagon may have a side slightly longer or shorter than the others, etc. For example, even when described as “circular” etc., such descriptions refer to an overall general shape, and any deviations, especially at the boundary with the fingers, are expected.

The fingers, are prepared from a polyurethane, rubber, or other elastomer, often the same polyurethane, rubber, or other elastomer as the body. In embodiments, the body and fingers may be formed as a single piece, in a single molding process, from the same elastomeric material. In alternative embodiments, the fingers and body may be formed from different elastomeric materials, may be formed in separate processes, and/or may be joined together to form an integral disc unit. As mentioned above, different numbers of fingers may be present, e.g., in various embodiments there may be 2-18, 3-18, 4-16, 4-12, 5-12, 6-10 or 6-8 fingers. In some embodiments of the invention the disc has six fingers. In other embodiments the star disc has 8, 10 or 12 fingers, and in some other embodiments the star disc has an odd number of fingers, e.g., 5, 7, 9 or 11.

The fingers may be understood to have an effective length (EL), a least one thickness (th), e.g., the maximum thickness (thmax) and minimum thickness (thmin) as defined above, and at least one width (w), wherein the width is measured in a plane perpendicular to that in which the thickness (th) is measured. The fingers may often be curved, but not always. The width and/or thickness of the fingers may vary as one progresses from the body perimeter to the distal end of the finger. In other embodiments the width and/or thickness of the fingers may be constant for most or all of the finger's length. The distal end of the finger may have any shape and may have a different thickness and/or width than other parts of the finger.

In many commercial discs, and in embodiments of the discs of the invention, the width of the fingers will be the same as, or similar to, the width of the body. Some discs may have an integral hub or spacer, typically near the opening for the shaft, that makes the body thicker in that region, and in such discs the width of the fingers will often be less than the width of this portion of the body. Alternatively, instead of integrated hubs, spacer members may be placed between discs to correctly position and space the discs on the shaft with respect to one another. In such embodiments without hubs, the width of the entire disc may be essentially the same. Since wear of spacer members may be minimal in comparison with the wear of the discs, spacer members may not need to be replaced, and a configuration of spacer members and discs may provide for a material/cost savings over an extended period of time as the discs without hubs could be formed with slightly less material than the same discs with integral hubs.

In embodiments, the discs of the invention may be single piece discs, typically with a slit or slice through the body wall to allow the disc to be spread open for mounting on a shaft. Alternatively, some embodiments may provide single piece discs with no slit, wherein the discs may be mounted on a shaft by inserting the shaft through the disc opening and sliding the discs axially along the shaft. Other embodiments may provide a multi-piece disc. In various embodiments the disc may also comprise, a hinge, a separate mounting hub, a separate flange, a fastening means such as a bolt, etc., a separate device to keep the disc from opening, etc. Typically, the body and fingers of the disc are formed as an integral unit in the case of a one-piece disc, or, in the case of a multi piece disc, body portions and attached fingers are formed as integral units. When referring to a “one piece” or “single piece” disc, it is understood that this refers only to the main elastomeric portion of the disc, e.g., body, fingers, etc.

The overall size of the star disc of the invention can vary greatly, e.g., discs can have an outer diameter of from about 200 to about 1300 mm, sometimes larger, and weigh from 3 to 60 pounds. In some embodiments the outer diameter is from about 225 to 500 mm, e.g., from 225 to 400 mm. In one specific embodiment, the outer diameter may be about 325 to about 335 mm, e.g., approximately 330 mm. While the size of the inventive discs may vary, the fingers may still be configured to exhibit a degree of deflection of at least 16° at 50 lbs of force, typically 45 lbs, or 40 lbs. In another embodiment, the fingers are capable of a deflection of greater than 5 degrees at a force of 50 lbf (222 Newtons), preferably greater than 10 degrees at a force of 50 lbf (222 Newtons), particularly preferred greater than 16 degrees at a force of 50 lbf (222 Newtons)

In one embodiment the invention provides a multi-fingered sorting disc prepared from an elastomeric polymer and having an outer diameter of about 200 mm to about 1300 mm. The multi-fingered sorting disc may comprise a body having a radial perimeter, said perimeter generally defining a circle with a body diameter, and a central opening, said central opening having a size and shape selected to accommodate a shaft, and 3 to 16 fingers, e.g., from 4 to 12 or from 6 to 8 fingers, extending radially from the radial perimeter of the body, with each finger having: a base where the finger joins the body and an opposite distal end; an effective length measured along a straight line through the finger, extending from the body perimeter to the distal end, as shown in FIG. 1; at least one thickness; and at least one width, wherein the thickness is measured in a plane parallel to the plane of a circle defined by the distal ends of the fingers, and the width is measured in a plane perpendicular to the plane of a circle defined by the outer edges of the fingers; wherein EL is the effective length, BD is the body diameter, thmax is the thickness measured at the thickest part of the finger between the midpoint of the finger and the distal end, thmin is the thickness measured at the least thick part of the finger between the body perimeter and the part of the finger where thmax is measured, and wmid represents the width measured at the midpoint along the line of EL; and thmax/EL is less than or equal to 0.38, BD/EL is greater than or equal to 0.5, wmid/EL is less than or equal to 0.75; and the fingers exhibit a 16° deflection or more at 50 lbs of force. Generally, thmin/EL is less than or equal to 0.35.

In various embodiments thmax/EL may be from about 0.12 to about 0.38; from about 0.12 to about 0.36 or about 0.34; or from 0.15 or 0.18 to about 0.34 or 0.30; thmin/EL may be from about 0.12 to about 0.35 to about 0.34; from about 0.12 or 0.15 to about 0.3; from about 0.12 or 0.15 to about 0.25; or from about 0.15 to about 0.23; BD/EL may be from about 0.5 to about 1.1; from about 0.55 or 0.60 to about 1.0; from about 0.6 or 0.7 to about 0.8 or 0.95; and wmid/EL may be from about 0.4 to about 0.75; about 0.45 to about 0.7; about 0.5 to about 0.67; or about 0.55 to about 0.65.

The disc may comprise any suitable elastomeric polymer, e.g., polyurethane, rubber, or other elastomer, that provides a disc meeting at least the above deflection criteria. In embodiments where fingers are relatively shorter and/or thicker, e.g., wherein thmin/EL may be from about 0.30 to about 0.35, the selection of elastomer may be focused on using more flexible materials in order to meet the deflection criteria, e.g., polyurethanes having a 10% modulus of less than 1,000, typically less than 500, or less than 200 psi. On the other hand, when the star has longer and/or thinner fingers, as in the new, inventive design, e.g., wherein thmin/EL may be from about 0.12 to about 028, the inherent flexibility of the elastomer is less important.

In some embodiments, discs of the invention may include a multi-fingered sorting disc prepared from an elastomeric polymer, in particular a polyurethane, and having an outer diameter of about 200 mm to about 1300 mm. The multi-fingered sorting disc may comprise a body as defined above, and 3 to 16 fingers, e.g., from 4 to 12 or from 6 to 8 fingers, e.g., six fingers, extending radially from the radial perimeter of the body, with each finger having a base where the finger joins the body at the radial perimeter, and an opposite distal end; an effective length of 60 to 375 mm, measured along a straight line through the finger extending from the body perimeter to the distal end; at least one thickness of from 15 to 130 mm; and at least one width of from 40 to 260 mm; wherein thmax/EL is less than or equal to 0.38, e.g., from about 0.12 to about 0.36, from about 0.12 or 0.15 to about 0.34, or from about 0.12 or 0.15 to about 0.30; wherein the fingers exhibit a deflection of at least 16° at 50 lbs of force, typically 45 lbs, 40 lbs, 35 lbs, or 30 lbs or in a further embodiment wherein the fingers are capable of a deflection of greater than 5 degrees at a force of 50 lbf (222 Newtons), preferably greater than 10 degrees at a force of 50 lbf (222 Newtons), particularly preferred greater than 16 degrees at a force of 50 lbf (222 Newtons); wherein the disc optionally has a slit through the body as described above, and wherein the disc of this embodiment is prepared from an elastomer that allows for the disc to be opened wide enough at the slit to accommodate the desired shaft under conditions of normal use, e.g. by using a force of typically less than 100, 75, or 50 lbf. to open the slit.

In some embodiments, the value for thmin/EL ranges from 0.1 to 0.32, 0.1 to 0.30, 0.12 to 0.30. As examples, a lower end of the range may be about 0.10, 0.12, 0.15, 0.18, 0.20, 0.22, or 0.25, and an upper end to the range may be about 0.20, 0.22, 0.25, 0.28, 0.30, or 0.32.

In some embodiments, the value for wmid/EL will range from 0.20 to 0.63. As examples, a lower end of the range may be about 0.2, 0.3, 0.4, 05, and an upper end to the range may be about 0.35, 0.45, 0.55, or 0.60.

One particular embodiment of the invention provides a disc having an outer diameter of 325 to 335 mm, a body diameter of 100 to 160 mm, e.g., 100 to 140 mm, six arched or curved fingers with an effective length of 85 to 125 mm, e.g. 95 to 120 mm, a thmax of from 22 to 34 mm, a thmin of from 18 to 28 mm, and a width of 50 to 70 mm, wherein the body and the fingers are manufactured as a single piece from a polyurethane elastomer or rubber, e.g., a polyurethane, selected to provide the fingers with at least a 16° deflection at a force of 50 lbs, 45 lbs, 40 lbs, 35 lbs, 30 lbs, 25 lbs, or in another embodiment wherein the fingers are capable of a deflection of greater than 5 degrees at a force of 50 lbf (222 Newtons), preferably greater than 10 degrees at a force of 50 lbf (222 Newtons), particularly preferred greater than 16 degrees at a force of 50 lbf (222 Newtons).

For example, one disc embodiment of the invention that meets the deflection requirements above has an outer diameter of approximately 330 mm, a body diameter of 115 to 125 mm, six arched or curved fingers with an effective length of 105 to 115 mm, a thmax of from 28 to 34 mm, a thmin of from 18 to 24 mm, and a width of 55 to 65 mm, wherein the body and the fingers are manufactured as a single piece from a polyurethane elastomer or rubber, e.g., a polyurethane. In some embodiments, the polyurethane may be prepared by curing a prepolymer with an amine curative, e.g. a diamine such as MOCA.

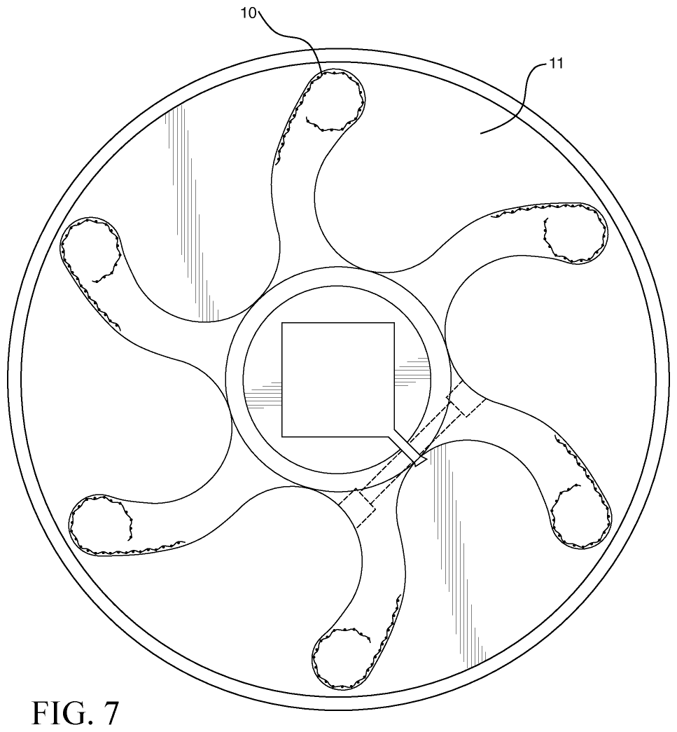

In some particular embodiments, the elastomeric disc of the invention further incorporates metallic and/or non-metallic fillers, fibers, fabrics, and/or mesh reinforcement material to reduce wear. It is often desirable to selectively incorporate such reinforcement into the polymer matrix in areas of the part that experience wear, cut, tears or other damage during use. In one example wire mesh was molded into the end of the fingers of an old newspaper star using a liquid urethane that was cured into an elastomer providing high wear resistance while maintaining the desired flexibility for the application. As shown in FIG. 7, in one embodiment, a wire mesh (FIG. 7, Nr. 10) is positioned in a polyurethane casting mold (FIG. 7, Nr. 11) as the means to incorporate the wire mesh into the casted sorting disk.

In some further embodiments, the elastomeric disc of the invention further incorporates metallic and/or non-metallic fillers, fibers, fabrics, and/or mesh reinforcement material to reduce wear. It is often desirable to selectively incorporate such reinforcement into the polymer matrix in areas of the part that experience wear, cut, tears or other damage during use. In one example wire mesh was molded into the end of the fingers of an old newspaper star using a liquid urethane that was cured into an elastomer providing high wear resistance while maintaining the desired flexibility for the application.

The inventive discs generally have greater finger deflection than commercial counterparts and greater durability. In some embodiments, this is accomplished by preparing a disc with the same size and shape of a commercial disc, but making the disc from a different elastomeric material that leads to greater finger deflection.

The commercial disc used as a standard in the initial experiments had the shape illustrated in FIG. 1 with outer diameter of 330 mm; a body diameter of 155 mm, a body width of 60 mm; a square 60 mm×60 mm center hole; a hub having a diameter (HD) of 100 mm, and a width of 100-105 mm; fingers with an effective length of 90 mm, a thickness at the thinnest point as defined above of 28.5 mm, a finger thickness measured at the thickest point of the distal end of 32.25 mm, and a width of 60 mm. The disc was made of rubber and the fingers had a 1″ deflection force of 52 lbf.

One disc embodiment of the invention, that took twice the time as the commercial disc to lose 10% of its mass, was of the same size and shape as the above commercial rubber disc, but was made from a polyurethane prepared from a toluene diisocyanate (TDI) terminated polyester prepolymer (Adiprene® LF1700) cured with an amine curative {4,4-methylenebis(2-chloroaniline)} The fingers of the resultant disc had a 1″ deflection force of 36 lbf.

In other embodiments, the discs of the invention had a different shape, which shape provided fingers with a lower deflection force. For example, the table below shows how a disc of the invention with an inventive design compares to the commercial standard above.

| | | Commercial Std | | INV Design | |
|---|---|---|---|---|---|
| Star Dimension | | | | | |
| Finger Thickness, Max | thmax | 32.25 | mm | 32.10 | mm |
| Finger Thickness, Min | thmin | 28.50 | mm | 22.50 | mm |
| Finger Width | w | 60.0 | mm | 60.0 | mm |
| Effective Length | EL | 90.0 | mm | 107.60 | mm |
| Outer Diameter | OD | 330 | mm | 330 | mm |
| Body Diameter | BD | 155 | mm | 119 | mm |
| Hub Diameter | HD | 100 | mm | 100 | mm |
| Wall Thickness | WaT | 35.10 | mm | 17.15 | mm |
| Ratio's | | | | | |

| | | | |
|---|---|---|---|
| Width/ | w/ | 0.67 | 0.56 |
| Effective Length | EL | | |
| Thickness, max/ | thmax/ | 0.36 | 0.30 |
| Effective Length | EL | | |
| Thickness, min/ | thmin/ | 0.32 | 0.21 |
| Effective Length | EL | | |
| Body Diameter/ | BD/ | 0.58 | 0.90 |
| Effective Length | EL | | |

The disc of the invention may be formed from a single elastomer, e.g., rubber or polyurethane elastomer, from more than one elastomer, or an elastomer and other materials. In embodiments, at least the body and fingers are formed as a single piece, in a single molding process, from one or more polyurethane, typically by cast molding using a curing composition comprising one or more isocyanate capped polyurethane prepolymer and one or more curative comprising, e.g., a polyol, e.g., diol, or amine, e.g., a diamine. The prepolymer may be prepared from a polyol, often a diol, and a polyisocyanate, often a di-isocyanate.

While polymers having a Shore hardness of about 80A have generally been considered optimal, with the embodiments of the invention, excellent results have been obtained with polyurethane elastomers having a Shore hardness over a range of from 65 to 90A. In the present work, hardness was not a determining factor in durability of the disc or usable lifetime. Given the importance of lowering the force required for finger deflection, it appears that using polymers with lower modulus, e.g., 10%, 25%, 50% 100% modulus, would provide greater durability, e.g., a 10% modulus of less than 1,000, 500, 250 or 100 psi, or a 100% modulus of less than 1,000, 500, 400, 250 or 100 psi.

The one or more polyols used in the preparation of the present prepolymers and polyurethane elastomers may be selected from any polyol, for example, polyether polyols, polyester polyols, polycaprolactone polyols, polycarbonate polyols, co-polyester polyols, alkane polyols, or mixtures thereof. In embodiments the polyol will have a number average molecular weight from about 200, 250 or 400 to about 6,000 or 10,000 Daltons. In some embodiments, a lower molecular weight polyol may also be present. In embodiments, diols may be preferred over triols and polyols having a larger number of hydroxyl groups.

Polyether polyols may typically be selected from polyalkylene ether polyols represented by the general formula HO(RO)ₙH, wherein R is an alkylene radical and n is an integer large enough that the polyether polyol has a number average molecular weight of at least 250. Representative polyols may include polyethylene glycols, polypropylene glycols (PPG), copolymers from propylene oxide and ethylene oxide (PPG-EO glycol), poly(tetramethylene ether) glycol PTMEG or PTMG, and the like.

The polyester polyols may typically be prepared by reaction of dibasic acids, e.g., adipic, glutaric, succinic, azelaic, sebacic, or phthalic acid or derivatives thereof, with diols such as ethylene glycol, 1,2-propylene glycol, 1,4-butylene glycol, 1,6-hexylene glycol, and alkylene ether polyols such as diethylene glycol, polyethylene glycol, polypropylene glycols, polytetramethylene ether glycol and the like. Polyols such as glycerol, trimethylol propane, pentaerthythritol, sorbitol, and the like may be used if chain branching or ultimate cross-linking is sought. Examples of polyester polyols may include poly(adipate) glycol, poly(hexamethylene adipate) glycol, poly(ethylene adipate) glycol, poly(diethylene adipate) glycol, poly(ethylene/propylene adipate) glycol, poly(trimethylolpropane/hexamethylene adipate) glycol, poly(ethylene/butylene adipate) glycol, poly(butylene adipate) glycol, poly(hexamethylene/neopentyl adipate) glycol, poly(butylene/hexamethylene adipate) glycol (PBHAG), poly(neopentyl adipate) glycol, and the like including copolymers and terpolymers thereof.

Polylactone polyols may include those made by polycondensation of, e.g., a caprolatone such as ε-caprolactone, and the like, often initiated by a small polyol such as ethylene glycol.

Hydrocarbon polyols may be prepared from ethylenically unsaturated monomers such ethylene, isobutylene, and 1,3-butadiene, e.g., polybutadiene polyols and the like.

The polyisocyanate monomers may be selected from any polyol, but in many embodiments di-isocyanates are employed. Aromatic and aliphatic isocyanate monomers are known and may be used, and may include, for example, paraphenylene diisocyanate(PPDI), toluidine diisocyanate (TODI), isophorone diisocyanate (IPDI), 4,4′-methylene bis (phenylisocyanate) (MDI), toluene-2,4-diisocyanate (2,4-TDI), toluene-2,6-diisocyanate (2,6-TDI), mixture of toluene-2,4-diisocyanate and toluene-2,6-diisocyanate (TDI), naphthalene-1,5-diisocyanate (NDI), diphenyl-4,4′-diisocyanate, dibenzyl-4,4′-diisocyanate, stilbene-4,4′-diisocyanate, benzophenone-4,4′diisocyanate, 1,3- and 1,4-xylene diisocyanates, 1,6-hexamethylene diisocyanate, 1,3-cyclohexyl diisocyanate, 1,4-cyclohexyl diisocyanate (CHDI), the three geometric isomers of 1,1′-methylene-bis(4-isocyanatocyclohexane) (abbreviated collectively as H₁₂ MDI), and mixtures thereof.

In embodiments of the invention, the polyol may comprise a polyether diol, such as a polyethylene glycol, polypropylene glycol, copolymer from propylene oxide and ethylene oxide, poly(tetramethylene ether) glycol PTMEG, and the like, a polyester diol, such as poly(hexamethylene adipate) glycol, poly(ethylene adipate) glycol, poly(diethylene adipate) glycol, poly(ethylene/propylene adipate) glycol, poly(trimethylolpropane/hexamethylene adipate) glycol, poly(ethylene/butylene adipate) glycol, poly(butylene adipate) glycol, poly(hexamethylene/neopentyl adipate) glycol, poly(butylene/hexamethylene adipate) glycol (PBHAG), poly(neopentyl adipate) glycol, and the like, including copolymers and terpolymers thereof, and/or a polycaprolactone diol.

Generally, when forming an isocyanate capped prepolymer, an excess of isocyanate monomer may be reacted with a polyol yielding a prepolymer containing unreacted isocyanate monomer. It has been shown that the amount of unreacted poly-isocyanate monomer present in the preoplymer composition can also affect the properties of the polyurethane elastomer, and in some embodiments of the invention, a “low free monomer” prepolymer, i.e., a prepolymer having less than 1 wt %, 0.5 wt %, 0.1 wt % or 0.05 wt % may be used to prepare the polyurethane, e.g., PUR 1, PUR 2, and PUR 3 in the provided examples.

Curing agents useful in the polyurethane curing composition may include any polyurethane curing agents, e.g., diols, triols, tetrols, higher polyols, diamines, triamines, higher polyamines, and the like, and more than one curing agent may be present. A small sampling of common curing agents useful in the present invention may include: C₂₋₁₂ alkylene diols such as ethylene glycol, 1,3-propanediol, 1,4-butanediol, 1,5-pentanediol, 1,6-hexanediol, neopentyl glycol, trimethylol propane, 1,10-decanediol, 1,1-cyclohexane dimethanol, 1,4-cyclohexane dimethanol, cyclohexane diol and the like;

hydroquinone-bis-hydroxyalkyl ethers such as hydroquinone-bis-hydroxyethyl ether, diethylene glycol etc.; ether diols such as dipropylene glycol, dibutylene glycol, triethylene glycol and the like; and a variety of diamines including ethylene diamine, hexamethylene diamine, isophorone diamine, xylylene diamine, methylenedianiline (MDA), naphthalene-1,5-diamine, ortho, meta, and para-phenylene diamines, toluene-2,4-diamine, dichlorobenzidine, diphenylether-4,4′-diamine,4,4′-methylene-bis(3-chloroaniline) (MBCA), 4,4′-methylene-bis(3-chloro-2,6-diethylaniline) (MCDEA), diethyl toluene diamine (DETDA), tertiary butyl toluene diamine (TBTDA), dimethylthio-toluene diamine, trimethylene glycol di-p-amino-benzoate, 1,2-bis(2-aminophenylthio)ethane, and methylenedianiline-sodium chloride complexes.

Any of the materials above, and any mixture of the materials above, may be used to prepare the elastomers for the present invention. In certain embodiments, excellent results are obtained using MDI or TDI prepolymers cured with amino curatives, such as MOCA, MDA/NaCl coordination complex. While the hardness of the polyurethane may not be considered to be particularly limited, polyurethanes with a hardness in the range of shore 55A to shore 95A may be used, e.g., from 60A to 90 A.

In some embodiments, a rubber may be used in the preparation of a star disc of the invention, e.g., a star disc of a modified design. Some synthetic rubbers that may be used include:
BR Polybutadiene
ABR Butadiene/C1-C4-alkyl acrylate copolymers
IR Polyisoprene
ESBR Styrene-butadiene copolymers having from 1-60% by weight styrene contents, preferably from 20-50% by weight, produced via emulsion polymerization
SSBR Styrene-butadiene copolymers having from 1-60% by weight styrene contents, preferably from 15-45% by weight, produced via solution polymerization
IIR Isobutylene-isoprene copolymers
NBR Butadiene-acrylonitrile copolymers having from 5 to 60% by weight acrylonitrile contents, preferably from 10-40% by weight
HNBR Partially hydrogenated or fully hydrogenated NBR rubber
EPDM Ethylene-propylene-diene terpolymers and mixtures of the rubbers.

In embodiments, the elastomer of the invention may comprise additives such as anti-oxidants and other stabilizers, processing aids, catalysts and catalysts residues, dispersants, colorants, fillers, silicones, reinforcing agents including fibers or fabrics, tackifiers or other friction modifiers, plasticizers, lubricants, anti-stats, flame retardants, and the like. In some embodiments of the invention, an additive such as a polysilicone may be used to improve physical properties such as hardness, rebound, fatigue, wear, etc.

### Examples

In the following examples, polyurethane star discs for test series 1 and 2 were prepared by casting polyurethane curing compositions in a single cavity mold to produce a split, six-finger, single-piece, old newspaper (ONP) star to form elastomeric discs having six fingers approximately 90 mm long, an outside diameter of approximately 330 mm, a body diameter of 155 mm, a hub width of approximately 105 mm, a hub diameter of 100 mm, a finger thmax of 32.25 mm, a finger thmin of 28.5 mm, a finger width of approximately 60 mm, and a 60 mm×60 mm square central opening with a single through-bolt to mount the star onto a rectangular shaft.

The resulting discs were field tested on a Lubo Star Screen Machine against commercial six-fingered rubber discs in sorting recyclable materials. Discs were considered to have failed when damaged or worn to the extent that a finger or part of a finger was broken off, other catastrophic physical damage occurred, 10% of the original mass was lost, etc.

Test Series 1

The initial goal of Series 1 was to find polyurethane elastomer that could be used in a star disc to improve durability and double the amount of time to reach a 10% loss of mass relative to the commercial standard rubber disc. Experimental polyurethane star discs with the same dimensions were prepared from the following prepolymers and curatives and molded according to known methods. A selection of the physical properties of the elastomers are shown in the table. The prepolymers of PUR 1-3 comprised less than 1 wt % of free isocyanate monomer.

PUR 1: MDI/aliphatic adipate glycol prepolymer, diol curative

PUR 2: MDI/caprolactone prepolymer, MDA/NaCl coordination complex curative

PUR 3: MDI/polyether prepolymer, MDA/NaCl coordination complex curative

PUR 4: TDI/polyether prepolymer, aromatic diamine curative

PUR 5: MDI/polyether prepolymer, diol curative

PUR 6: MDI/polyester prepolymer, diol curative

| Property | Rubber | PUR 1 | PUR 2 | PUR 3 | PUR 4 | PUR 5 | PUR 6 |
|---|---|---|---|---|---|---|---|
| Hardness | 71 A | 80 A | 89 A | 88 A | 79 A | 87 A | 81 A |
| 100% Modulus, psi | 545 | 632 | 1038 | 1005 | 580 | 879 | 765 |
| 300% Modulus, psi | 1484 | 941 | 1471 | 1390 | 1053 | 1760 | 1811 |
| Tensile psi | 1539 | 4592 | 4926 | 5421 | 4422 | 3725 | 6989 |
| Split Tear lbf/in | 58 | 60 | 100 | 90 | 83 | 45 | 94 |
| Rebound Bayshore, | 44% | 65% | 59% | 62% | 53% | 61% | 24% |
| Compression Set, | 37% | 54% | 60% | 42% | 94% | 24% | 35% |
| 25% 22 hrs | | | | | | | |
| @ 100° C. | | | | | | | |
| DIN Abrasion | 150 | 7 | 15 | 8 | 35 | 48 | 54 |
| Volume Loss (mm³) | | | | | | | |

Tensile strength is determined by ASTM D412

Tear Strength—Split Tear is determined by ASTM D470, lbf/in.

Rebound is determined by ASTM D2632

DIN Abrasion, is determined by ASTM D5963, Method A 10 Newtons

Modulus is determined by ASTM D575.

Despite the greater strength and abrasion resistance of each polyurethane used in the preparation of the experimental star discs for test series 1, the commercial rubber disc exhibited durability comparable to any of the experimental discs.

PUR 7:

ONP stars were cast using the mold described above and a toluene diisocyanate (TDI) terminated polyester prepolymer with less than 1 wt % free TDI (Adiprene® LF1700) cured with an amine curative {4,4-methylenebis(2-chloroaniline)}. The prepolymer having an NCO content of 2.41 wt % was heated overnight for 16 hours at 70° C. to lower the viscosity. Approximately 1.5 grams of BYK 359 was added to 2786 grams of prepolymer (0.05 weight percent based on the prepolymer), mixed in a Vortex at approximately 650 rpms for 15 seconds, placed in a microwave to increase the temperature to 95° C. then degassed for 10 minutes under vacuum. 214 grams of MOCA was melted at approximately 125° C., degassed for 10 minutes under vacuum, added to the prepolymer, and mixed in a Vortex mixer at approximately 650 rpms for 15 seconds. A pre-heated mold (surface temperature 98.5 C) was removed from the oven and the mixture was poured into the cavity to cast a part. The mold was placed back into the oven. The urethane was cured for 1 hour at 105° C. then post cured for 16 hours at 105° C. The urethane part was removed and conditioned for 7-days at room temperature before being placed into service.

Four of the PUR 7 stars were mounted on the fifth shaft in the center of a Lubo Star Screen Machine. Four rubber stars were mounted on the forth shaft to compare the durability performance of urethane stars. The machine is situated at about a 40 degree incline. The fifth shaft is located in the middle of the impact zone on the bottom portion of the machine where the material being separated is propelled from an overhead conveyor onto the lower section, impacting the rotating stars and shafts. This area on the machine typically experiences the most wear.

The thickness and width of the fingers near the tip were measured as a function of the operating time, which can be correlated with weight loss and shown in the tables below.

| | | | T = 0 hr | T = 28 hr | T = 155 hr | T = 227 hr | T = 326 hr | T = 443 hr | T521 |
|---|---|---|---|---|---|---|---|---|---|
| Rubber | Shaft | Location | th/mm | th/mm | th/mm | th/mm | th/mm | th/mm | th/mm |
| PUR 7 | 5 | FR | 32.31 | 32.71 | 30.44 | 32.28 | 29.72 | 25.14 | 23.94 |
| | 5 | R | 32.26 | 32.09 | 29.75 | 31.08 | 24.78 | 25.92 | 24.79 |
| | 5 | L | 32.24 | 32.73 | 29.61 | 30.64 | 26.63 | 25.49 | 24.16 |
| | 5 | FL | 32.24 | 32.50 | 29.34 | 30.90 | 29.14 | 28.65 | 27.66 |
| average | | | 32.26 | 32.51 | 29.79 | 31.23 | 27.57 | 26.31 | 25.14 |
| Rubber | 4 | FR | 32.29 | 32.15 | 29.06 | 26.78 | Replaced | — | — |
| | 4 | R | 32.32 | 31.20 | 30.46 | 26.03 | ″ | — | — |
| | 4 | L | 32.37 | 32.95 | 29.10 | 25.17 | ″ | — | — |
| | 4 | FL | 32.44 | 32.96 | 29.38 | 27.25 | ″ | — | — |

| | | | | | | | |
|---|---|---|---|---|---|---|---|
| average | 32.36 | 32.32 | 29.50 | 26.31 | — | — | — |

Test Series 2

The following table compares the time to failure, 10% wt loss, of the PUR 7 and rubber discs above as well as additional experimental polyurethane star discs prepared from the same mold. Hours represent machine operation hours.

PUR 7: TDI/aliphatic polyester prepolymer, MOCA, Shore 66A

PUR 8: Plasticized MDI/polyester prepolymer, MDA/NaCl coordination complex, Shore 75A

PUR 9: TDI/aliphatic polyester prepolymer, MOCA curative, Shore 81A

PUR 10: MDI/aliphatic polyester prepolymer, diol curative, Shore 81A

PUR 11: MDI/aliphatic polyether prepolymer, MDA/NaCl coordination complex, Shore 88A

| | Shaft | split tear | 1″ deflection | |
|---|---|---|---|---|
| Material | position | lbf/in | lbf | Lifetime* |
| Rubber | 4 | 58 | 52 | <326 |
| PUR 7 | 5 | 36 | 35 | 521 |
| PUR 8 | 6 | 87 | 107 | 306 |
| PUR 9 | 7 | 111 | 113 | 521 |
| PUR 10 | 5, 6, 7 | 94 | 70 | 297-521* |
| PUR 11 | 5 | 90 | >200 | 155 |

*hours to loss of 10% mass

The disc prepared from PUR 7 exhibited excellent durability despite having very low split tear strength and being tested in the most destructive region of the screen.

Test Series 3

Based on the finding in Series 2 suggesting that increasing deflection of the fingers may significantly improve durability, a new design for the star disc was developed wherein the girth of the fingers was lessened. A new series of polyurethane test discs were made, including discs prepared from PUR 7. The tested discs are exhibiting improved performance.

What is claimed is:

1. An elastomeric sorting disc for use with a sorting apparatus, said disc comprising
a disc body configured in a generally circular or generally ovoid shape defining a radial perimeter at an outer edge of the body from which a body diameter is measured,
a plurality of fingers integrally formed as appendages joined to the body at said perimeter, each finger extending outwardly from the radial perimeter to an outer edge, wherein the outer edges of the fingers of the disc define a circle from which an outer diameter is measurable;
wherein said body has a centrally positioned axial opening therethrough of a size and shape capable to fit onto a shaft of said apparatus,
wherein said body optionally has a slit formed through the wall of the body from the perimeter of the body to the axial opening, and
wherein the fingers are capable of a deflection of greater than 5 degrees at a force of 50 lbf (222 Newtons), preferably greater than 10 degrees at a force of 50 lbf (222 Newtons), particularly preferred greater than 16 degrees at a force of 50 lbf (222 Newtons).

2. The elastomeric sorting disc according to claim 1 comprising 4-16 fingers, preferably 6-8, particularly preferred 6.

3. The elastomeric sorting disc according to claim 1, wherein the disc comprises polyurethane.

4. The elastomeric sorting disc according to claim 1, comprising:
an effective length (EL) measured along a straight line through the finger extending from the radial perimeter to the outer edge of the finger,
at least one thickness measured in a plane parallel to the plane of the circle defined by the outer radial edges of the fingers, and
at least one width measured in a plane perpendicular to the plane of the circle defined by the outer edges of the fingers;
wherein
thmax is the thickness measured at the thickest part of the finger between the midpoint of the finger and the outer edge;
thmin is the thickness measured at the least thick part of the finger between the radial perimeter and the part of the finger where thmax is measured;
wmid represents the width measured at the midpoint along the line of EL;
thmax/EL is less than or equal to 0.38, preferably about 0.15 to about 0.34,
thmin/EL is less than or equal to 0.35, preferably about 0.12 to about 0.25,
BD/EL is greater than or equal to 0.5, and
wmid/EL is less than or equal to 0.75.

5. The elastomeric sorting disc according to claim 4, wherein:
the EL is about 60 to about 375 mm,
the disc has one or more thicknesses of about 15 to about 130 mm, and
the disc has at least one width of about 40 to about 260 mm.

6. The elastomeric sorting disc according to claim 4, wherein:
the OD is about 325 to about 335 mm,
the BD is about 100 to about 140 mm,
the EL is about 85 to about 125 mm,
thmax is about 22 to about 34 mm,
thmin is about 18 to about 28 mm, and
wmid is about 50 to about 70 mm.

7. The elastomeric sorting disc according to claim 4, wherein:
the OD is about 330 mm,
the BD is about 115 to about 125 mm,
the disc has six curved fingers,
the EL is about 105 to about 115 mm,
thmax is about 30 to about 34 mm,
thmin is about 20 to about 24 mm. and
wmid is about 55 to about 65 mm.

8. The elastomeric sorting disc according to claim 4, wherein:
thmax/EL is about 0.18 to about 0.30;
thmin/EL is about 0.18 to about 0.23; and
BD/EL is about 0.6 to 1.0.

9. The elastomeric sorting disc according to claim 1, formed of a polyurethane elastomer.

10. The elastomeric sorting disc according to claim 9, wherein the body and fingers are formed as a single piece, in a single molding process, from the same polyurethane elastomer.

11. The elastomeric sorting disc according to claim 9, wherein:
the polyurethane elastomer is prepared by crosslinking an isocyanate capped prepolymer with an amine curative.

12. The elastomeric sorting disc according to claim 9, wherein:
the body and fingers are formed as a single piece, in a single molding process, from the same polyurethane elastomer material;
the polyurethane elastomer material is a polyurethane elastomer prepared by crosslinking an isocyanate capped prepolymer with an amine curative;

13. The elastomeric sorting disc according to claim 9, further comprising metallic and/or non-metallic fillers, fibers, fabrics, and/or mesh reinforcement material.

14. The elastomeric sorting disc according to claim 13 wherein said metallic and/or non-metallic fillers, fibers, fabrics, and/or mesh reinforcement material are position at or near the end of the fingers.

15. The elastomeric sorting disc according to claim 13, wherein the reinforcement material is a metal mesh.

16. A method for improving the durability of an elastomeric sorting disc for a disc sorting apparatus, the disc comprising a disc body and a plurality of fingers extending radially from the body, and the method comprising, in comparison with fingers of conventional discs, increasing deflection of the fingers, or at least portions of the fingers, by at least one of making the fingers, thinner, longer, or both thinner and longer than the fingers of conventional discs, and forming at least the fingers with an elastomer comprising properties leading to increased deflection.

17. The method according to claim 16, wherein the deflection of the fingers, or portions of the fingers, is increased by selecting an elastomer with a 10% modulus of less than 1000, preferably with a 100% modulus of less than 1000 as measured according to ASTM D575.

18. The method according to claim 16, wherein the deflection of the fingers, or portions of the fingers, is increased by making the fingers thinner, longer, or both thinner and longer.

19. The method according to claim 16, wherein the method further comprises incorporating metallic and/or non-metallic fillers, fibers, fabrics, and/or mesh reinforcement material, either throughout the entire disc or only in certain regions.

20. The method according to claim 19 wherein the metallic and/or non-metallic fillers, fibers, fabrics, and/or mesh reinforcement material is incorporated at or near the end of the fingers.
